(19) United States
(12) Patent Application Publication
(10) Pub. No.: US 2026/0145751 A1
(43) Pub. Date: May 28, 2026

(54) DEPLOYABLE WHEEL GAP REDUCER FOR A VEHICLE AND METHOD OF OPERATING THE SAME

(71) Applicant: FCA US LLC, Auburn Hills, MI (US)

(72) Inventors: Arturo Guzman-Magana, Auburn Hills, MI (US); Santiago Antonelli, Auburn Hills, MI (US); Prathap Krishnan, Chennai (IN)

(21) Appl. No.: 18/960,514

(22) Filed: Nov. 26, 2024

(51) Int. Cl. B62D 37/02

(52) U.S. Cl. CPC B62D 37/02

(57) ABSTRACT

A method and system for deploying a deployable wheel gap reducer includes determining a vehicle speed for a vehicle. Based on the vehicle speed, the deployable wheel gap reducer is extended from the wheel opening of the vehicle toward a tire of the vehicle.

### FIELD

The present disclosure relates to a wheel openings for a vehicle, and more specifically, to a deployable wheel gap reducer and a system for deploying the same.

### BACKGROUND

This section provides background information related to the present disclosure which is not necessarily prior art.

Many vehicles must be able to package different tire sizes and, in addition, be able to package winter tire cables on the tires as well. This combined with the suspension travel increases the wheel volumes. As a result, vehicles end up with large wheel-arch-to-tire gaps or wheel gap. The wheel gap allows air to be ingested, which reduces the efficiency of the vehicle. Large wheel gaps affect aerodynamics of the vehicle. In some active suspension systems, the vehicle body is lowered to reduce the wheel gap under certain operating conditions.

### SUMMARY

This section provides a general summary of the disclosure, and is not a comprehensive disclosure of its full scope or all of its features.

The present system and method provide a wheel gap reducer to improve the airflow around the vehicle.

In one aspect of the disclosure, a method for deploying deployable wheel gap reducer includes determining a vehicle speed for a vehicle. Based on the vehicle speed, the deployable wheel gap reducer is extended from the wheel opening of the vehicle toward a tire of the vehicle.

In another aspect of the disclosure, a system for a vehicle includes a deployable wheel gap reducer and a vehicle speed sensor determining a vehicle speed for the vehicle. A controller deploys the deployable wheel gap reducer to extend from the wheel opening of the vehicle toward a tire of the vehicle based on the vehicle speed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a partial perspective view of a vehicle having a deployable wheel gap reducer in a retracted position.

FIG. 1B is the vehicle of FIG. 1A with the wheel gap reducer deployed.

FIG. 1C is a lateral cross-sectional view of the vehicle with the wheel arch air bag deployed.

FIG. 1D is a lateral cross-sectional view of the vehicle with a wheel liner air bag deployed.

FIG. 1E is a lateral cross-sectional view of the vehicle with a movable trim component movable in response to the wheel arch air bag.

FIG. 2 is a perspective view of the air distribution system according to the present disclosure.

FIG. 3A is side view of a vehicle having an undeployed wheel gap reducer.

FIG. 3B is a side view of the vehicle of FIG. 3A with the wheel gap reducer deployed.

FIG. 4 is a high level block diagrammatic view of the wheel gap reducer control system according to the present disclosure.

FIG. 5 is a flowchart of a method for deploying the wheel gap reducer.

Corresponding reference numerals indicate corresponding parts throughout the several views of the drawings.

### DETAILED DESCRIPTION

Example embodiments will now be described more fully with reference to the accompanying drawings.

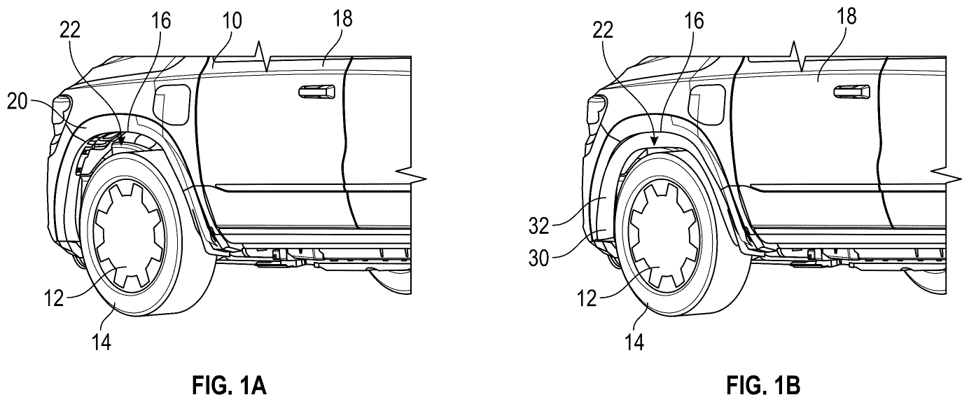

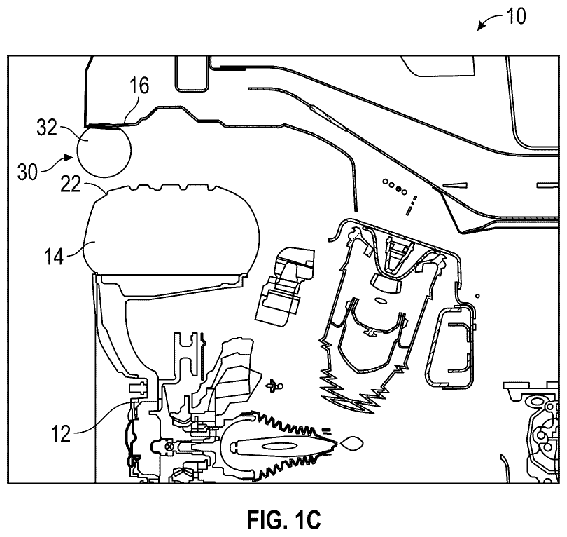

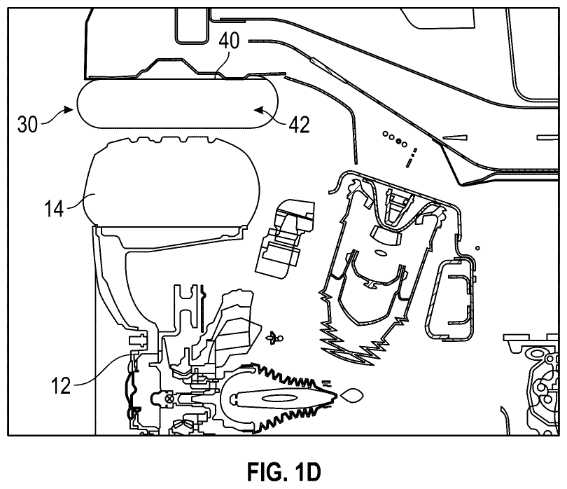

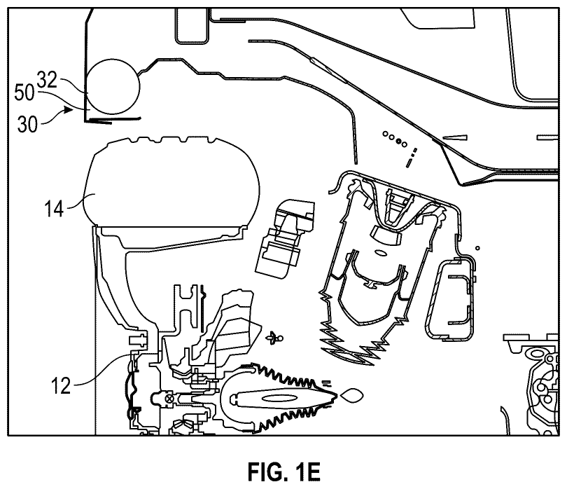

Referring now to FIG. 1A, a portion of a vehicle 10 is illustrated. The vehicle 10 has a wheel 12 and a tire 14 on the wheel. A wheel arch 16 is disposed around at least portion in the wheel. The arch 16 may be formed within the body 18 of the vehicle. The arch 16 may be decorated with a trim piece 20. However, the arch 16 may also be formed of the body material. A wheel gap 22 is disposed between the tire 14 and the arch 16. As mentioned above, having a large gap 22 reduces the overall aerodynamic efficiency of the vehicle because air from the vehicle traveling may be ingested within the wheel gap 22.

Referring now to FIG. 1B, a deployable wheel gap reducer 30 is illustrated. In this example, the wheel gap reducer 30 is an air bag 32 that forms a deployable wheel arch and is coupled to the wheel arch 16 and reduces the amount of wheel gap 22. The wheel arch 16 is downward facing and therefore the under or downward facing surface of the wheel arch or wheel liner is used to secure the deployable wheel gap reducer 30 therefrom. The wheel gap reducer 30 may be inflatable and takes up at least a portion of the wheel gap 22 to reduce the amount of air ingested within the wheel gap.

A partial lateral cross-sectional view of the vehicle 10 is illustrated. In this example, the air bag 32 is used as the wheel gap reducer 30. The air bag 32 extends into the wheel gap 22 so that only a narrow portion of air is disposed therebetween.

Referring now to FIG. 1D, the wheel gap reducer 30 is coupled to a wheel liner 40. The wheel liner 40 has the air gap reducer 30 coupled thereto. In this example, the wheel gap reducer 30 is a deployable wheel liner 42.

Referring now to FIG. 1E, the wheel arch air bag 32 may be used alone, as is illustrated in FIG. 1C, or together with a movable trim component 50. That is, the movable trim component 50 may move toward the tire 14 upon deployment and away from the tire upon retraction. This provides a more aesthetically pleasing view of the vehicle 10.

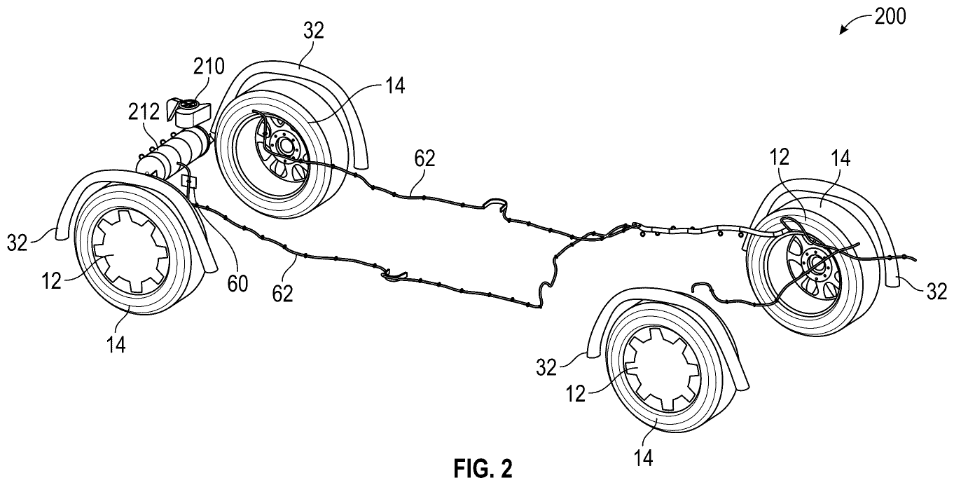

Referring now to FIG. 2, the air distribution system 200 is illustrated in greater detail. In this example, an air compressor 210 is used to pressurize air in an air tank 212. The air tank 212 may be referred to as an accumulator to store compressed air. The compressed air may be communicated through a valve 60 to air lines 62 to all of the air bags 32 or the deployable wheel liner 42. By providing air through the air lines 62 to each of the air bags 32 or deployable wheel liners 42, the air bags 32 or liners 42 may be deployed as desired. Likewise, the air bags may also be retracted by bleeding air to the environment or reducing the pressure in the tank 212 so that air is removed from the air lines 62 and air bags 32.

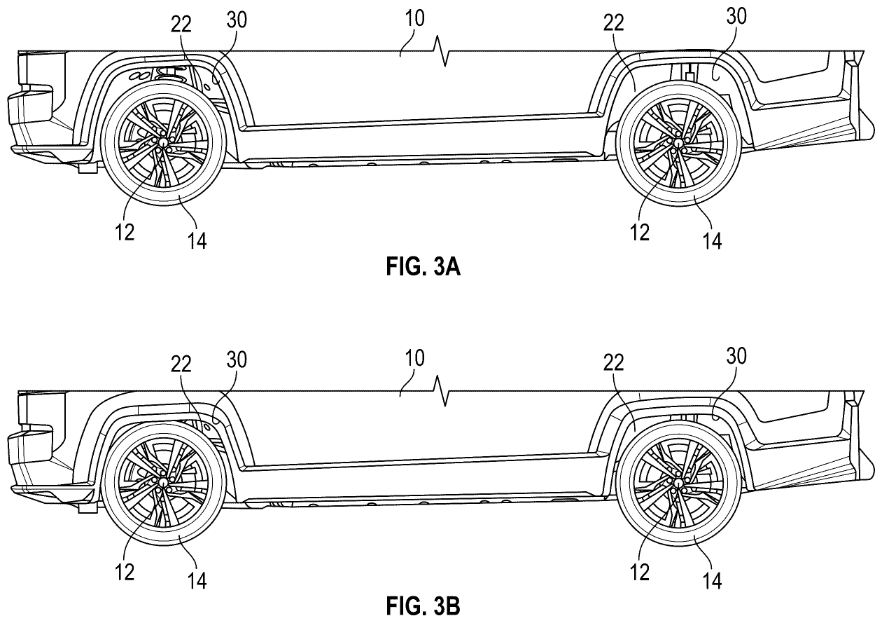

Referring now to FIGS. 3A and 3B, a side view of the vehicle 10 is illustrated with two arches. In FIG. 3A, the wheel gap reducer is retracted. In FIG. 3B, the wheel gap reducer 30 is deployed to reduce the wheel gap 22.

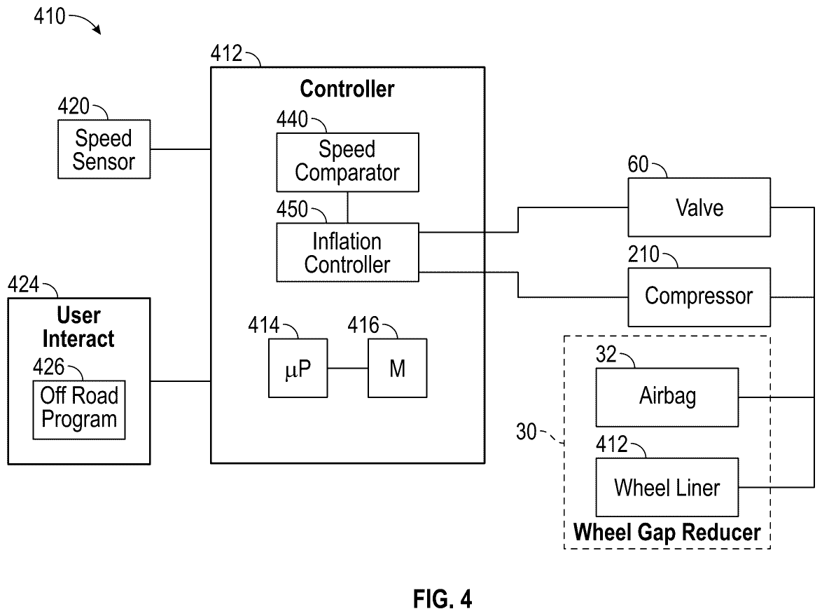

Referring now to FIG. 4, a control system 410 for controlling the deployment of the airbag 32 or wheel liner 42 is set forth. The controller 24 is illustrated having a microprocessor or processor 414 and a memory 416. The microprocessor or processor 414 is programmed to control the operation of the airbag 32 or wheel liner 42 into a deployed and retracted position. The memory 416 is a non-transitory, computer-readable medium including machine readable instructions that are executable by the processor 414 for controlling the deployment and retraction of the airbag 32 and wheel liner 42. The machine readable instructions allow the processor 414 to be programmed to perform function deploy and retract the airbag 32 and wheel liner 42 under predetermined conditions.

The controller 24 is in communication with a vehicle speed sensor 420. The vehicle speed sensor 420 generates a vehicle speed signal that corresponds to the speed of the vehicle 10.

The controller 24 is also in communication with a user interface 424. The user interface 424 may be buttons, dials, a touchscreen or combinations thereof. The user interface 424 may be used for selecting an off-road program 426 to prevent deployment of the wheel gap reducer. In an off-road scenario, the deployment of the airbag 32 or wheel liner 42 may not be desirable due to the potential for sudden wheel movements and debris build-up.

The controller 24 has a speed comparator 440. The speed comparator 440 may receive the speed signal from the speed sensor 420 and compare the speed with one or more speed thresholds. In this example, the speed threshold may be a high speed or first threshold. The speed comparator 440 may have a high speed or first threshold therein. The airbag 32 or wheel liner 42 may be deployed when a high speed such as a speed greater than 55 mph is achieved. By deploying the airbag 32 and wheel liner 42, the wheel gap 22 is reduced and lowers the drag on the vehicle 10 as illustrated in FIG. 1B. The airbag 32 or the wheel liner 42 may be retracted when the speed is reduced below the first threshold or below a second threshold lower than the first threshold.

An inflation controller 450 is provided within the controller 412. The inflation controller 450 receives the speed comparison signal from the speed comparator 440. In response to the signal, the inflation controller 450 controls one of the compressor 210 or the valve 60. The inflation controller 450 ultimately allows the airbag 32 or the wheel liner 42 to deploy or retract. That is, when the speed comparator 440 detects the speed is lower than a threshold, the inflation controller 450 may retract the airbag 32 and wheel liner 42.

The air source may be air tank 212 which may be part of a stand-alone system or part another device. The air tank 212 provides pressurized airflow to deploy the deployable airbag or wheel liners. One example of an air source within a vehicle is an air suspension. The air suspension may be an active suspension that uses compressed air to achieve the desired settings for the suspension.

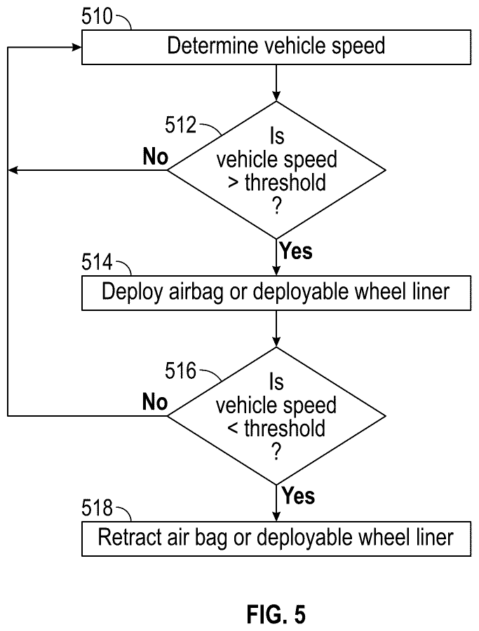

Referring now to FIG. 5, a method for operating the system is set forth. In step 510, the speed of the vehicle is determined. The speed sensor 420 of FIG. 4 may be used to determine the speed of the vehicle. In step 512, if the speed is greater than a first threshold, step 514 deploys wheel gap reducer 30 such as the airbag 32 or the wheel liner 42 to reduce the wheel gap 22 between the arch and the tire. That is, the wheel gap reducer 30 may be coupled to the wheel liner 40 or arch 16 to reduce the gap with the tire 14.

After step 514, the system determines whether the vehicle speed has dropped below the threshold in step 516. In step 516, the vehicle speed is less than the speed threshold. Step 518 retracts the air bag or deployable wheel liner. In steps 512 or 516, when the answer is negative, the system repeats to step 510.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
determining a vehicle speed for a vehicle; and
based on the vehicle speed, deploying deployable wheel gap reducer to extend from the wheel opening of the vehicle toward a tire of the vehicle.

2. The method of claim 1 further comprising determining the vehicle speed comprises determining the vehicle speed is greater than a first speed threshold.

3. The method of claim 1 wherein deploying the deployable wheel gap reducer comprises deploying the deployable wheel gap reducer by inflating the deployable wheel gap reducer.

4. The method of claim 1 wherein deploying the deployable wheel gap reducer comprises deploying the deployable wheel gap reducer by inflating a deployable wheel arch.

5. The method of claim 1 wherein deploying the deployable wheel gap reducer comprises deploying the deployable wheel gap reducer by inflating a deployable wheel liner.

6. The method of claim 1 wherein deploying deployable the deployable wheel gap reducer comprises deploying deployable wheel arches by inflating the deployable wheel arches and moving a trim piece toward the tire in response to moving the trim piece.

7. The method of claim 1 further comprising preventing deployment of the deployable wheel gap reducer in response to a user interface.

8. The method of claim 1 further comprising preventing deployment of the deployable wheel gap reducer in response to an off-road setting of a user interface.

9. The method of claim 1 wherein prior to deploying, pressurizing an air tank using a compressor.

10. The method of claim 1 wherein deploying comprises communicating pressurized airflow to a plurality of wheel gap reducers.

11. The method of claim 1 wherein deploying comprises communicating pressurized airflow to a plurality of wheel gap reducers through a plurality of air lines from an air tank.

12. The method of claim 1 further comprising retracting the wheel gap reducer based on the vehicle speed.

13. A system for a vehicle comprising:
a deployable wheel gap reducer;
a vehicle speed sensor determining a vehicle speed for the vehicle; and
a controller deploying the deployable wheel gap reducer to extend from the wheel opening of the vehicle toward a tire of the vehicle based on the vehicle speed.

14. The system of claim 13 wherein the controller deploys the deployable wheel gap reducer when the vehicle speed greater than a first speed threshold.

15. The system of claim 13 wherein the wheel gap reducer comprises a deployable wheel arch.

16. The system of claim 15 further comprising a trim piece disposed between a wheel arch of the vehicle and the deployable wheel arch and moving the trim piece toward the tire in response to moving the trim piece.

17. The system of claim 13 wherein the wheel gap reducer comprises a deployable wheel liner.

18. The system of claim 13 further comprising a user interface comprising an off-road setting, said controller preventing deployment of the deployable wheel gap reducer in response to the off road setting.

19. The system of claim 13 wherein the deployable wheel gap reducer comprises a plurality of wheel gap reducers.

20. The system of claim 19 further comprising an air tank coupled to a compressor and a plurality of air lines coupling the air tank to the plurality of wheel gap reducers.
